(19) United States
(12) Patent Application Publication
(10) Pub. No.: US 2007/0210272 A1
(43) Pub. Date: Sep. 13, 2007

(54) Quick installation ball valve

(76) Inventor: Corrado Giacomini, Orta S. Giulio (NO) (IT)

Correspondence Address: YOUNG & THOMPSON, 745 SOUTH 23RD STREET, 2ND FLOOR, ARLINGTON, VA, 22202, US

(21) Appl. No.: 11/517,257

(22) Filed: Sep. 8, 2006

(30) Foreign Application Priority Data
Mar. 13, 2006 (IT) MI2006A 000441

(51) Int. Cl. F16L 29/00

(52) U.S. Cl. 251/148

(57) ABSTRACT

A quick installation valve including a valve body consisting in one or more parts and in which a shutter is housed which is rotatable by a lever-like control element or similar, and is provided with an inlet end and an outlet end, wherein at least one of the valve ends is designed as an integrated quick coupling body and houses a quick coupling assembly for housing and tightly fastening a metal pipe or a plastic hose.

### FIELD OF THE INVENTION

The present invention relates to a quick installation ball valve, particularly for the use in fluid distributing plants, heating plants and sanitary plants according to the preamble of claim 1.

### BACKGROUND OF THE INVENTION

At present in fluid distributing plants, heating plants and sanitary plants are used ball valves having different embodiments and sizes, wherein in order to facilitate and to obtain a quick installation of said plants it is known to associate to the known ball valves so-called “quick couplings”.

Said quick couplings are known in several embodiments, wherein the latter at one end thereof are screwed onto a first valve end and at the other end house a pipe or hose to be tightly secured in the other valve end.

The known quick couplings are carried out in embodiments for fastening both metal pipes and plastic hoses and are widely used since more than 15 years.

The known ball valves may have a body made of one or more pieces, wherein the inlet end and outlet end of the valve body are provided with an external or an inner screw thread, that is with a male or a female thread, and said ends themselves or a middle part of said valve body are provided with a polygonal part, generally an hexagonal part, for receiving a fork wrench for fastening purposes.

The quick couplings are screwed in said threaded valve body ends.

It is evident that the realization of said threaded valve body ends requires own working and metal costs which contribute to the formation of the manufacture costs.

It is also known the fact that in the body of the quick couplings a threaded end is provided which is to be screwed in a threaded valve end. Also for these coupling threaded parts of said quick couplings arise specific metal and manufacturing costs.

The valves housing at the ends thereof said quick couplings have between the external ends of said mounted quick couplings a length which is greater than the length of the valve without the mounted quick couplings which obviously increases the valve overall dimensions and may lead to installation difficulties in the case of a small installation room.

What set forth with reference to a ball valve is also valid for other types of valves such as gate valves, cocks and the like so that in this application within the term “ball valve” are also included valves having any embodiment which is suitable to be provided with quick couplings.

### SUMMARY OF THE INVENTION

Accordingly, the aim of the present invention is to provide a quick installation ball valve comprising at least one quick coupling for the use in fluid distributing plants, heating plants and sanitary plants, which ball valve allows to reduce the production costs and to speed up the installation time.

According to the present invention, the above mentioned aim is achieved by a ball valve having the features of claim 1.

Further advantageous embodiments are inferable from the dependent claims.

The quick installation ball valve according to the present invention provides several and important advantages. At first, the execution in at least a valve end of a quick coupling integrated in the valve body allows to eliminate both the machining of the thread on a valve body end and the coupling thread working on an end of the quick coupling while obtaining a correspondent reduction of the valuable metal (brass, steel, bronze, copper) for manufacturing the ball valve as well as the quick coupling as well as a correspondent reduction of the length of the assembly valve-quick coupling, wherein said reduction of the overall dimensions of said assembled valve is particularly advantageous in case of installation conditions in small installation rooms as the latter are oft present in the installation of fluid distributing plants, heating plants and sanitary plants.

The above mentioned advantages concerning a valve with a quick coupling at one end thereof are still more important in the case of a valve provided with a quick coupling at both valve ends. A further advantage is to be seen in the fact that the integration of quick couplings in the body of a ball valve can occur irrespective of the embodiment of the valve body in one, two or three pieces as said integration is carried out at the inlet and outlet valve ends which are in any case provided in any valve.

Still another advantage is to be seen in the sensible saving of valuable metal with respect to the traditional valves having the same diameter of the valve ball shutter as said ball valves are valves produced in huge numbers so that a metal saving, even if moderate, in each valve leads to a great metal saving in consideration of the great number of produced valves. This is also valid in relation with the reduced manufacturing time which is obtained by avoiding the threading machining of the valve ends and the quick couplings.

On the contrary the hot-pressed or casting time of the valve bodies is not practically changed as this time does not vary in consequence of the integration into the valve body of one or both the valve ends designed as quick coupling bodies.

A further advantage is to be seen in the elimination of the assembling time which is necessary with the known valves for securing the quick couplings on the valve ends, wherein said time reduction contributes in speeding up the installation of the fluid distributing plants, heating plants and sanitary plants in which a great number of valves and quick couplings is used.

With the integration of the quick couplings bodies into the valve body it is further possible to avoid the previously needed keeping in stock of said quick couplings bodies.

### BRIEF DESCRIPTION OF THE DRAWINGS

Further advantages, details and features of the quick installation ball valves according to the present invention will become more apparent hereinafter from the following disclosure with reference to several embodiments of a ball valve according to the present invention which are shown in the accompanying drawings, in which partially schematically

FIG. 1 is a schematic, partially sectional view of a ball valve with two quick couplings before the assembling of the latter onto the valve according to the prior art,

FIG. 2 shows the valve of FIG. 1 with the quick couplings after the assembling thereof with the valve,

FIG. 3 shows schematically a valve according to the present invention having a valve body in three pieces and quick couplings bodies integrated in both the valve ends,

FIG. 4 shows a perspective view of a first version of the valve schematically shown in FIG. 3, with a valve body in two pieces,

FIG. 5 shows a side view of the valve with integrated quick couplings shown in FIG. 4,

FIG. 6 shows a front view of the valve in FIG. 5, seen according to the arrow F, and

FIG. 7 shows a perspective view of a third embodiment of a valve according to the present invention having a valve body in two pieces and an internal hexagonal part to be engaged by a wrench fork.

### DESCRIPTION OF THE PREFERRED EMBODIMENTS

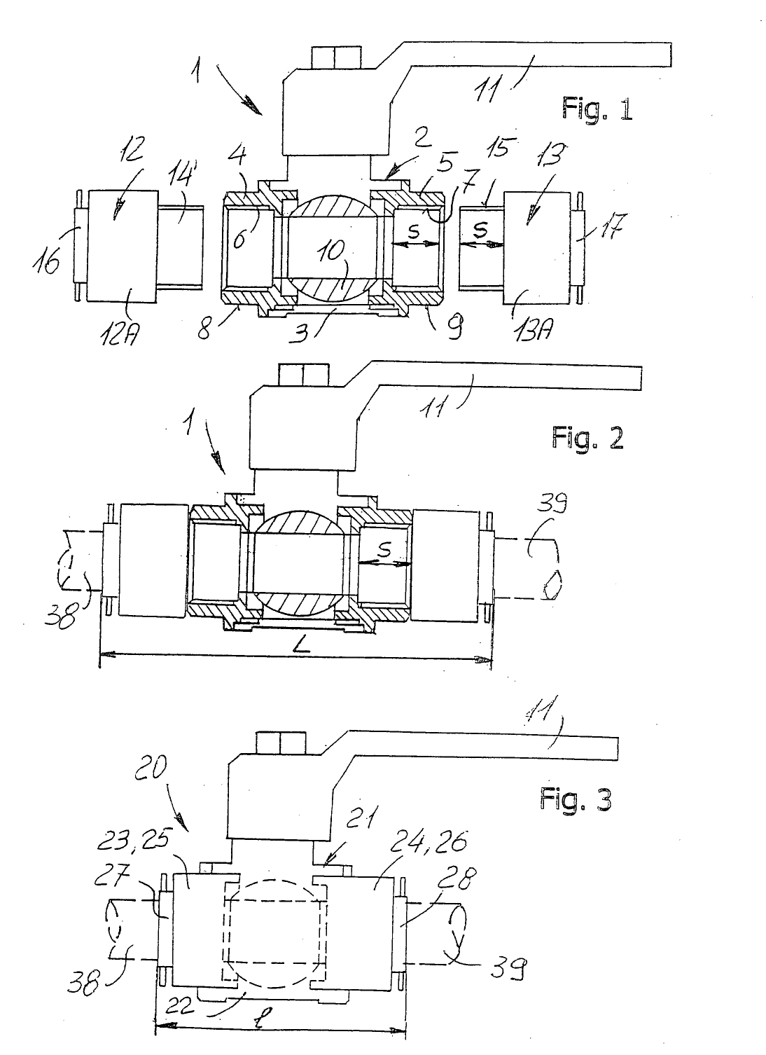

Reference is first made to the FIGS. 1 and 2 depicting the prior art and in which 1 denotes a known ball valve having a hot-pressed body 2 made for example of brass and formed, in the shown example, by a middle part 3 and two lateral parts 4, 5 defining the inlet and outlet ends respectively, or vice versa. Said lateral parts 4 and 5 are provided, in the shown example, as female ends having an internal thread 6, 7 and an external conformation like an hexagon 8, 9.

The ball shutter and the control lever associated therewith are indicated by 10 and 11, respectively.

For using quick couplings with the valve 1 it is known to use quick couplings 12, 13 the bodies of which 12A and 13A are provided with a male thread 14, 15 to be screwed into the female threads 6, 7 of the valve 1.

The quick couplings 12, 13 have an internal quick coupling assembly or group 16, 17 for metal pipes or plastic hoses, wherein said quick coupling groups 16, 17 can be provided with components or conformations at will.

By screwing said quick couplings 12, 13 onto the valve 1 is obtained an assembled or compound valve 1 as shown in FIG. 2 in which with “s” is indicated the length of said threads 6, 14, respectively 7, 15, and with “L” is indicated the total length of the assembled valve 1 which latter is affected by the disadvantages set forth hereinabove.

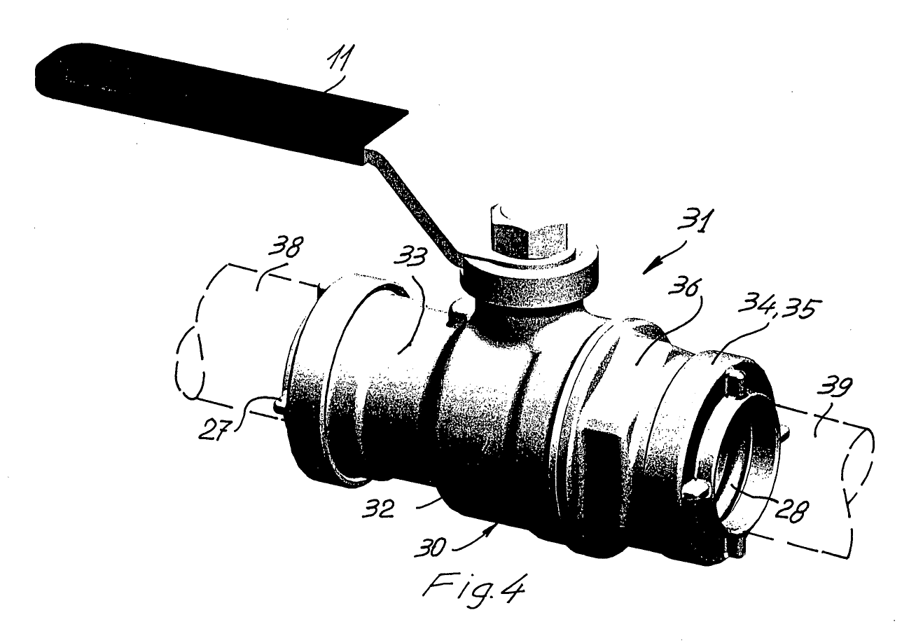

Reference is now made to FIG. 3 in which the valve 20 according to the present invention has a valve body 21, for example a likewise hot-pressed brass body, having a middle part 22 which is similar to the middle part 3 of the known valves, as well as two end portions 23, 24 which are obtained in one piece with the middle part 22 and which form the bodies of two quick couplings 25, 26 the quick coupling groups 27, 28 of which could have a conformation or designs at will, that is both for metal pipes and for plastic hoses 38, 39 shown with a dashed line.

From the FIG. 3 is inferable that the elimination of the coupling threaded parts 6, 14 and 7, 15 of the valve and known quick couplings allows the achievement of a length “1” of the integrated valves 20 which is shorter with respect to the length “T” of the known assembled valves, wherein is obtained 1=L−2s.

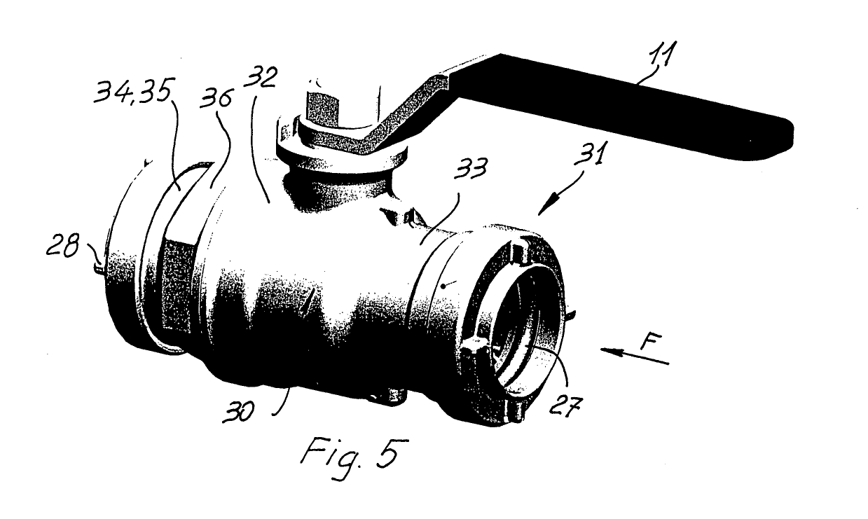

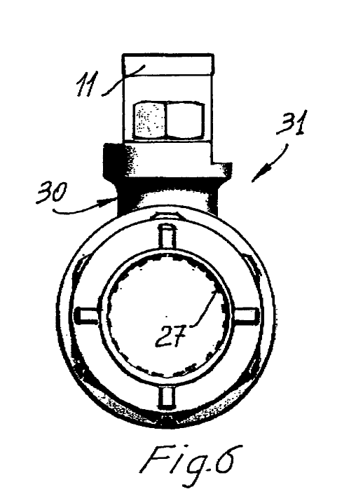

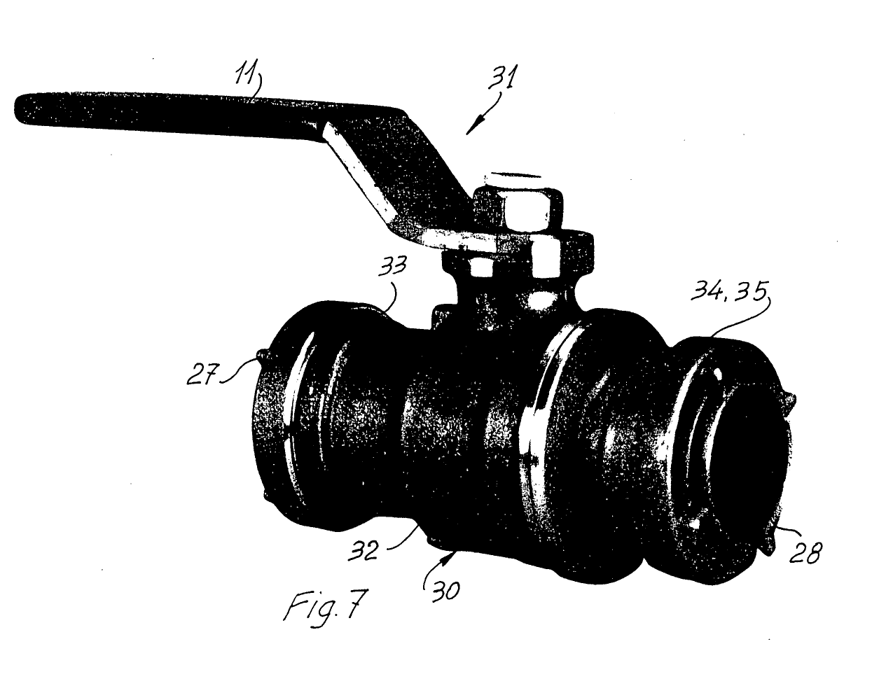

Another embodiment of a ball valve allowing a quick installation thereof according to the present invention is shown in the FIGS. 4, 5 and 6.

With respect to the valve having a body in three pieces as shown in FIG. 3 in the integrated valve shown in the FIGS. 4, 5 and 6 the body 30 of the integrated valve 31 is made of two parts, and more precisely of a middle-lateral part 32 (corresponding to the body parts 22 and 24 of the valve of FIG. 3) and a part 34 which forms an end 35 of the valve 31 and incorporates said hexagonal part 36. Both said lateral end part 33 of the middle-lateral part 32 and said end part 35 represent bodies of quick couplings the quick coupling groups of which are again denoted by 27 and 28.

In the valve illustrated in FIG. 7 the external hexagon 36 has been eliminated and it has been substituted by an internal, not shown, hollow hexagon which is provided inside an end of the valve body or quick coupling body, wherein said internal hexagon may be engaged by a rod hexagonal wrench which is coaxially insertable from the outside. This version allows a further metal saving as the hexagonal outline is substituted by a circular one.

During the installation of the integrated valves 20 and 31 according to the present invention the insertion and securing of the pipes or hoses 38, 39 occur in a known manner, wherein the smaller overall dimension of the valve according to the invention facilitates the installation thereof also in small room conditions. The installation time is further shortened due to the fact that the quick couplings are already integrated into the valve and do not require a preliminary fastening thereof to the valve body, as usually with the known valves.

The valves according to the present invention may be indifferently provided with one or two quick couplings.

From the above constructional and functional disclosure of the quick installation ball valves according to the present invention, it should be apparent that with the latter it is possible to efficiently attain the mentioned object and achieve the stated advantages.

As mentioned hereinabove, the teaching according to the present invention to incorporate in the valve body quick couplings either in one or both ends of ball valves may also be utilized with any other embodiment of valves or cocks.

1. A quick installation valve comprising a valve body consisting in one or more parts and in which a shutter is housed which is rotatable by means of a lever-like control element or similar, and is provided with an inlet end and an outlet end, characterized in that at least one of said valve ends is designed as an integrated quick coupling body and houses a quick coupling assembly for housing and tightly fastening a metal pipe or a plastic hose.

2. A ball valve according to claim 1, characterized in that both valve ends are designed like quick coupling bodies housing quick coupling assemblies for fastening metal pipes or plastic hoses.

3. A ball valve according to claim 2, characterized in that it is externally provided with at least a polygonal, for example an hexagonal, conformation which may be engaged by a wrench fork.

4. A ball valve according to claim 2, characterized in that it is internally provided with at least an hollow polygonal, for example an hexagonal conformation which may be engaged by a rod-like wrench which is insertable from the outside.

5. A ball valve according to claim 1, characterized in that it has a hot-pressed or cast metal body made, for example, of brass, steel, bronze or the like.

6. A ball valve according to claim 1,
characterized in that it has a plastic body.

7. A ball valve according to claim 1,
characterized in that it has a body made of two pieces.

8. A ball valve according to claim 1,
characterized in that it has a body made of three pieces.

9. A ball valve according to claim 1,
characterized in that it has a one-piece body.
